(19) United States
(12) Patent Application Publication
(10) Pub. No.: US 2021/0044479 A1
(43) Pub. Date: Feb. 11, 2021

(54) TECHNIQUE FOR ESTABLISHING A COMMUNICATION HIERARCHY AMONG A PLURALITY OF DEVICES

(71) Applicant: Telefonaktiebolage LM Erisson (publ), Stockholm (SE)

(72) Inventors: Fredrik GUNNARSSON, Linköping (SE); Jan HEDEREN, Linghem (SE); Thomas RIMHAGEN, Linköping (SE); Wei SHEN, Linköping (SE); Jingcheng ZHANG, Svärtinge (SE)

(73) Assignee: Telefonaktiebolage LM Erisson (publ), Stockholm (SE)

(21) Appl. No.: 16/967,809

(22) PCT Filed: Feb. 7, 2018
(86) PCT No.: PCT/EP2018/053011

§ 371 Date: Aug. 6, 2020

(51) Int. Cl. H04L 12/24; G16Y 30/00; H04W 76/10; H04W 8/00; H04W 84/20

(52) U.S. Cl. CPC H04L 41/0806; G16Y 30/00; H04W 84/20; H04W 8/005; H04W 76/10

(57) ABSTRACT

A technique for establishing a communication hierarchy among a plurality of devices (102) in an Internet of Things, IoT, environment (100) is disclosed. The communication hierarchy includes one or more parent-child relationships among the plurality of devices (102) defining communication paths to be used for communication between devices (102) on different levels of the communication hierarchy. A method implementation of the technique is performed by a first device of the plurality of devices (102) and comprises receiving, from a configurator component (104), a configuration request to establish a parent-child relationship with a second device (102) of the plurality of devices (102), and sending, to the second device (102), an establishment request to establish the parent-child relationship with the second device (102), wherein establishing the parent-child relationship includes establishing a connection between the first device (102) and the second device (102) usable for communication along a communication path in the communication hierarchy.

### TECHNICAL FIELD

The present disclosure generally relates to Internet of Things (IoT) environments. In particular, a technique for establishing a communication hierarchy among a plurality of devices in an IoT environment is presented. The technique may be embodied in methods, computer programs, apparatuses and systems.

### BACKGROUND

Over the recent years, IoT systems have evolved as systems of interrelated physical objects equipped with computing, networking and, optionally, sensing capabilities enabling the objects to collect and exchange data without requiring human-to-human or human-to-computer interaction. Objects equipped with these capabilities are sometimes also denoted as “IoT devices”. IoT systems may generally allow physical objects to be sensed and controlled autonomously, thereby enabling for a more direct integration of the physical world into computer-based systems. “Things” in the sense of IoT may refer to a wide variety of physical objects, such as, e.g., persons with heart monitor implants, animals with biochip transponders, automobiles with built-in sensors, logistics containers with smart labels, or any other natural or manmade objects that can be provided with the ability to transfer data over a network.

IoT systems generally enable building dynamic functional networks where aggregated and specific physical objects may be tracked by location, monitored and/or controlled with communication relationships over a wide area of use and physical deployments. One of the main purposes is to provide systems that offer efficiently controlled and reliable communication networks that connect the IoT devices throughout their lifecycle. However, one of the challenges of IoT systems is how to dynamically establish network mechanisms to provide a secure, trusted and robust information exchange between the IoT devices throughout their lifecycle, even across different contexts (e.g., physical locations or usages). Such information exchange may include the exchange and logging of physical locations or other status information of the IoT devices, for example.

### SUMMARY

Accordingly, there is a need for a technique that enables improved lifecycle management for IoT devices.

According to a first aspect, a method for establishing a communication hierarchy among a plurality of devices in an IoT environment is provided. The communication hierarchy includes one or more parent-child relationships among the plurality of devices defining communication paths to be used for communication between devices on different levels of the communication hierarchy. The method is performed by a first device of the plurality of devices and comprises receiving, from a configurator component, a configuration request to establish a parent-child relationship with a second device of the plurality of devices, and sending, to the second device, an establishment request to establish the parent-child relationship with the second device, wherein establishing the parent-child relationship includes establishing a connection between the first device and the second device usable for communication along a communication path in the communication hierarchy.

The communication hierarchy may correspond to a network topology for both upstream and downstream message communication between the plurality of devices in the IoT environment. When devices on different levels of the communication hierarchy communicate with each other, they may communicate along the communication paths defined by the parent-child relationships among the plurality of devices. In some variants, the devices may communicate along the communication paths defined by the parent-child relationships only. A communication path may either comprise a single parent-child relationship or a plurality of consecutive parent-child relationships that form a chain of parent-child relationships along which a message to be communicated from one device to another device may be forwarded. Thus, in a chain of parent-child relationships, a child device may forward a message to its assigned parent device, and the parent device may forward the message to its assigned parent device, and so on, e.g., until the message arrives at the desired destination. A child device may be a child for one device and may be a parent for another device. While a child device may only have one parent, a parent device may have multiple child devices. In other variants, a child device may also have multiple parents. In the communication hierarchy, circular relationships may not be permitted, e.g., a device may not be parent and child for another device at the same time.

In order to establish the communication hierarchy among the plurality of devices, a parenting procedure (also denoted as “pairing procedure”) may be performed under control of a configurator component. The configurator component may have (or have access to) parenting information defining the one or more parent-child relationships and may trigger—as part of the parenting procedure—establishing the parent-child relationships between respective pairs of the plurality of devices. The configurator component may in other words assign parent and child roles to the respective devices in the IoT environment. The plurality of devices may correspond to interrelated physical objects equipped with computing, networking and, optionally, sensing capabilities, as described above for IoT systems of the prior art.

For the purpose of establishing the parent-child relationship between the first device and the second device among the plurality of devices, the first device may receive, from the configurator component, as the trigger, a configuration request to establish the parent-child relationship with the second device. Upon receipt of the configuration request, the first device may send, to the second device, the establishment request to establish the parent-child relationship with the second device. Establishing the parent-child relationship with the second device may include establishing the connection between the first device and the second device usable for communication along a communication path in the communication hierarchy, as described above.

In one implementation, the first device may correspond to a parent device and the second device may correspond to a child device of the parent-child relationship. It will be understood, however, that the principles of the technique presented herein may likewise be practiced when the first device corresponds to the child device and the second device corresponds to the parent device of the parent-child relationship. The connection may be established using a stateful or a stateless communication protocol and establishing the connection may comprise performing an initial handshake required to set up the parent-child relationship between the first device and the second device. For this purpose, the configuration request sent from the configurator component to the first device may include configuration information required by the first device to establish the parent-child relationship with the second device. For example, the configuration information may include at least one of identification information of the second device (e.g., a device address and/or device type) and security information required for establishing the connection with the second device, such as authentication information expected by the second device (e.g., credentials), or encryption information (e.g., encryption keys) required for secure communication between the first device and the second device.

Before establishing the parent-child relationship with the second device, the first device may search for the second device (e.g., scan for the second device within its radio range) if the second device is not yet known or visible to the first device. The first device may thus detect a broadcast announcing presence of the second device and then match the configuration information (e.g., device address and/or device type) with information included in the broadcast to verify the identity of the second device. Similarly, to announce presence of the first device itself and thereby enable other entities in the IoT environment to detect the first device, such as the configurator component, the first device may, prior to receiving the configuration request, send a broadcast announcing presence of the first device. The broadcast may be sent periodically and, once detected by another entity, the first device may receive an acknowledgment in response to the broadcast, e.g., from the configurator component to inform the first device that a configurator component is available and within reach of the first device. The first device may also enter a sleep mode between periodic broadcasts to save energy, e.g., until an acknowledgment is received.

Upon acceptance of the establishment request for the parent-child relationship by the second device, the first device may receive, from the second device, an establishment response confirming acceptance of the parent-child relationship with the first device. Otherwise, when the second device has not accepted the establishment request, the first device may receive an establishment response indicating denial of the parent-child relationship from the second device. In case of acceptance by the second device, the first device may send, to the configurator component, a notification on completion of establishment of the parent-child relationship between the first device and the second device. A notification may similarly be sent in case of failure to establish the parent-child relationship to inform the configurator component accordingly.

As mentioned above, when a communication path between two devices on different levels of the communication hierarchy forms a chain of consecutive parent-child relationships, a child device may forward a message to its assigned parent device, and the parent device may forward the message to its assigned parent device, and so on. When the first device is thus additionally in a parent-child relationship with a third device of the plurality of devices, wherein the parent-child relationship with the third device is consecutive to the parent-child relationship with the second device, the first device may receive a message from the second device via the connection established between the first device and the second device, and the first device may forward the message to the third device via a connection established between the first device and the third device. The parent-child relationship and the corresponding connection between the first device and the third device may be established in an equivalent manner as described above for the parent-child relationship between the first device and the second device.

Whereas the first, second and third devices as well as, optionally, the configurator component may in some implementations establish connectivity among each other using wire-bound networks provided in the IoT environment, or using regular mobile communication networks, such as 4G or 5G networks, for example, in other implementations, the first device may communicate with at least one of the second device, the third device and the configurator component using low energy radio technology. This may particularly be the case when the first, second and third devices and, optionally, the configurator component are in close proximity to each other, i.e., when these entities are in reachable range to each other and may directly communicate with each other using low energy radio technology. Detecting the second device based on the broadcast and establishing a connection with the second device may then be carried out using low energy radio technology.

Low energy radio technology as known in the art may correspond to radio technology which provides considerably reduced power consumption as compared to classic radio technology. Low energy radio technology may comprise Low Power Personal Area Network (LP-PAN) radio technology, such as Bluetooth Low Energy (BLE), for example, which may support wireless radio ranges in the order of meters up to tens of meters and which may enable devices to work for long periods of time using a coin battery cell, for example. For a wider range, BLE Long Range (LR) technology may be employed in which networks having star or mesh topologies with intermediate relaying nodes may be provided. ZigBee is another exemplary LP-PAN radio technology which is particularly designed for low data rate, low power and low cost applications, whose transmission ranges are typically below 100 meters and which may similarly support star, mesh and cluster tree topologies. Low energy radio technology may also include Radio Frequency Identifier (RFID) technology which, in particular in case of active RFID, may support transmission radio ranges up to a few meters, such as three meters, for example. For wider ranges, it is also conceivable to employ Low Power Wide Area Network (LP-WAN) technology with transmission radio ranges of a few up to tens of kilometers and battery lives of several years, including Narrow Band IoT (NB-IoT) and Long Term Evolution for Machine Type Communications (LTE-MTC) operating in licensed band and Long Range Wide Area Network (LoRaWAN) and Sigfox operating unlicensed band, for example.

In addition to connectivity along the communication paths defined by the parent-child relationships in the communication hierarchy, as described above, the first device may further be equipped with Internet access and may therefore act as gateway device among the plurality of devices which is enabled to communicate—apart from the communication hierarchy (or as the uppermost level of the communication hierarchy if the Internet connection is considered as part of the communication hierarchy)—with a remote entity via the Internet. The first device may thus have an Internet connection and, when the first device receives a message from the second device via the connection established between the first device and the second device, the first device may forward the message to a remote entity via the Internet connection. To be able to access the remote entity, the first device may receive, from the configurator component, connectivity information (e.g., a network address, port information, security information and/or subscription information, as needed) for accessing the remote entity via the Internet connection. Alternatively, the connectivity information may already be preconfigured in the first device. Similar to establishing a connection with the second device, the first device may send an establishment request to establish connectivity (e.g., authenticate) with the remote entity and receive a corresponding response therefrom. The first device may then send a notification on the completion or failure of the connection establishment with the remote entity to the configurator component.

The remote entity may be a device management component which may be configured to keep track of the plurality of devices in the IoT environment (in particular of the locations of the devices when at least part of the devices are mobile or transportable), to monitor and keep track of the established parent-child relationships in the communication hierarchy, and to support the configurator component in the parenting procedures for establishing the communication hierarchy among the plurality of devices, for example. As another example, the remote entity may correspond to the configurator component in case the configurator component is a remote configurator component that may not be able communicate with the plurality of devices using low energy radio technology but only via the Internet through the gateway device, for example.

Further than the communication paths used for communication between the devices in the IoT environment, the communication hierarchy may further define a supervision hierarchy in which, for each of the one or more parent-child relationships, a parent device of the respective parent-child relationship monitors a status of a child device of the respective parent-child relationship. The parent-child relationships may in other words also be said to define supervision responsibilities among the plurality of devices in the IoT environment. When the first device corresponds to a parent device and the second device corresponds to a child device of the parent-child relationship, the first device may thus monitor a status of the second device and report the status of the second device accordingly. The first device may send a report along the upstream network topology of the communication hierarchy, e.g., as an event, and/or, when the first device is a gateway device, the first device may send the report via the Internet connection to the device management component, for example. Reports may be sent according to reporting configuration parameters, such as desired report types and/or report intervals, for example, which may be preconfigured in the first device or which may be included in the configuration information received from the configurator component. The reporting configuration parameters may also be included in the notification on completion or failure of the connection establishment between the first device and the second device sent to the configurator component in order to confirm the reporting configuration parameters towards the configurator component.

The reported status of the second device may generally relate to any status of the second device, including a connection status or a regular sensor status in case the second device comprises a sensor, for example. A connection status of the second device may be determined to be offline when it is detected that the parent-child relationship between the first device and the second device is broken. A parent-child relationship may be determined to be broken when connectivity between the first device and the second device is lost. Lost connectivity may be detected based on a message report interval (e.g., a heartbeat or a regular sensor report interval) that is sent periodically to keep alive the connection of the parent-child relationship. If a lost device reappears after a certain period of time, such device may no longer be considered as a valid device of the communication hierarchy and a reparenting procedure may be required to be executed. In case a parent device is considered as an invalid device, all of its child devices may be considered to be invalid as well and may need to be reparented.

According to a second aspect, a method for establishing a communication hierarchy among a plurality of devices in an IoT environment is provided. The communication hierarchy includes one or more parent-child relationships among the plurality of devices defining communication paths to be used for communication between devices on different levels of the communication hierarchy. The method is performed by a second device of the plurality of devices and comprises receiving, from a first device of the plurality of devices, an establishment request to establish a parent-child relationship with the first device, wherein establishing the parent-child relationship includes establishing a connection between the first device and the second device usable for communication along a communication path in the communication hierarchy.

The method according to the second aspect defines a method from the perspective of a second device which may be complementary to the method performed by the first device according to the first aspect. The first device and the second device of the second aspect may correspond to the first device and the second device described above in relation to the first aspect. As such, those aspects described with regard to the method of the first aspect which are applicable to the method of the second aspect may be comprised by the method of the second aspect as well, and vice versa. Unnecessary repetitions are thus omitted in the following.

As in the method of the first aspect, the first device may correspond to a parent device and the second device may correspond to a child device of the parent-child relationship. The establishment request may include at least one of identification information of the first device (e.g., a device address and/or device type) and security information required for establishing the connection between the first device and the second device, such as authentication information expected by the second device (e.g., credentials), or encryption information (e.g., encryption keys) required for secure communication between the first device and the second device.

In order to know about a device with which a parent-child relationship may be established, the second device may receive, prior to receiving the establishment request, device information from a configurator component, wherein the device information indicates from which device an establishment request for establishing a parent-child relationship is to be accepted. The configurator component may correspond to the configurator component described above in relation to the first aspect. Alternatively, the device information indicating from which device an establishment request for establishing a parent-child relationship is to be accepted may be preconfigured in the second device. The device information may comprise authentication information (e.g., credentials) expected to be received from the first device for authentication purposes and/or encryption information (e.g., encryption key) required to decrypt at least part of the establishment request, for example.

Upon receiving the establishment request from the first device, the second device may match the device information with information included in the establishment request (e.g., the identification information and the authentication information of the first device) to verify whether establishing the parent-child relationship with the first device is acceptable. The verification may also include decrypting at least part of the establishment request using the encryption information included in the device information received from the configurator component. Verification may fail when the decryption of at least part of the establishment request fails. Upon acceptance of the establishment request, the second device may send, to the first device, an establishment response confirming acceptance of the parent-child relationship with the first device. As an alternative to sending the notification on completion or failure of the connection establishment between the first device and the second device from the first device to the configurator component, as described in relation to the first aspect, such notification may also be sent by the second device.

In order to enable the first device and the configurator component to detect the second device, the second device may send, prior to receiving the establishment request from the first device, a broadcast announcing presence of the second device to other entities in the IoT environment. The broadcast may be sent periodically and, once detected by another entity, the second device may receive an acknowledgment in response to the broadcast, e.g., from the configurator component to inform the second device that a configurator component is available and within reach of the second device (e.g., nearby if communication with the configurator component is carried out using low energy radio technology). The second device may also enter a sleep mode between periodic broadcasts to save energy, e.g., until an acknowledgment is received.

As described in relation to the first aspect, when a communication path between two devices on different levels of the communication hierarchy comprises a plurality of consecutive parent-child relationships forming a chain of parent-child relationships, a child device may forward a message to its assigned parent device, and the parent device may forward the message to its assigned parent device, and so on. When the first device is thus additionally in a parent-child relationship with a third device of the plurality of devices, wherein the parent-child relationship with the third device is consecutive to the parent-child relationship with the second device, the second device may send a message to the first device via the connection established between the first device and the second device, wherein the message is dedicated for further delivery from the first device to the third device via a connection established between the first device and the third device. As in the method of the first aspect, the second device may communicate with at least one of the first device and the configurator component using low energy radio technology.

According to a third aspect, a method for establishing a communication hierarchy among a plurality of devices in an IoT environment is provided. The communication hierarchy includes one or more parent-child relationships among the plurality of devices defining communication paths to be used for communication between devices on different levels of the communication hierarchy. The method is performed by a configurator component and comprises sending, to a first device of the plurality of devices, a configuration request to establish a parent-child relationship with a second device of the plurality of devices, wherein establishing the parent-child relationship includes establishing a connection between the first device and the second device usable for communication along a communication path in the communication hierarchy.

The method according to the third aspect defines a method from the perspective of a configurator component which may be complementary to the method performed by the first device according to the first aspect and/or the method performed by the second device according to the second aspect. The first device, the second device and the configurator component of the third aspect may correspond to the first device, the second device and the configurator component described above in relation to the first aspect and/or the second aspect. As such, those aspects described with regard to the methods of the first and second aspects which are applicable to the method of the third aspect may be comprised by the method of the third aspect as well, and vice versa. Unnecessary repetitions are omitted in the following.

As in the methods of the first and second aspects, the first device may correspond to a parent device and the second device may correspond to a child device of the parent-child relationship. The configuration request may include configuration information required by the first device to establish the parent-child relationship with the second device and the configuration information may include at least one of identification information of the second device and security information required for establishing the connection with the second device.

Before sending the configuration request to the first device, the configurator component may search for the first device (e.g., scan for the first device within its radio range), and optionally the second device, if the first device and the second device are not yet visible to the configurator component. The configurator component may thus receive, prior to sending the configuration request, a broadcast from at least one of the first device and the second device announcing its respective presence. Further, in order to inform the second device about a device with which a parent-child relationship may be established, the configurator component may send, prior to sending the configuration request to the first device, device information to the second device, wherein the device information indicates to the second device from which device an establishment request for establishing a parent-child relationship is to be accepted. When the parent-child relationship has been successfully established between the first device and the second device, the configurator component may receive, from at least one of the first device and the second device, a notification on completion of establishment of the parent-child relationship between the first device and the second device. A notification may similarly be received in case of a failure in establishing the parent-child relationship.

The configurator component may be executed on a computing device configured to communicate with at least one of the first device and the second device using low energy radio technology. This may particularly be the case when the configurator component is in close proximity to the first device and the second device, i.e., when they are in reachable range to each other and may directly communicate with each other using low energy radio technology. The configurator component may in this case be a mobile computing unit, such as a smartphone or a laptop, for example, that may be employed locally (i.e., at a location where the first device and the second device are located as well) to trigger establishing the parent-child relationship between the first device and the second device. Such configurator component may be denoted as a local configurator component. As an alternative, the configurator component may be a remote configurator component that may not be able to communicate with the first device and the second device using low energy radio technology but only via the Internet if the first device and/or the second device is configured as a gateway device, as described above. A remote configurator component may reside in a cloud, for example.

The configurator component may have knowledge itself of the parent-child relationships of the communication hierarchy that are to be implemented during the parenting procedure (e.g., the configurator component may store the corresponding configuration itself), or the configurator component may obtain such knowledge from another entity, such as the device management component described above in relation to the first aspect. In the latter case, the configurator component may obtain, from the device management component, parenting information defining the one or more parent-child relationships of the communication hierarchy, and the configuration request sent from the configurator component to the first device may be (e.g., generated) based on the parenting information. Alternatively or additionally, at least part of the parent-child relationships may be configured manually by a user of the configurator component (in particular when the configurator component is a local configurator component), e.g., based on physical properties of the devices to be paired.

According to a fourth aspect, a computer program product is provided. The computer program product comprises program code portions for performing the method of at least one of the first, the second and the third aspect when the computer program product is executed on one or more computing devices (e.g., a processor or a distributed set of processors). The computer program product may be stored on a computer readable recording medium, such as a semiconductor memory, DVD, CD-ROM, and so on.

According to a fifth aspect, a first device for establishing a communication hierarchy among a plurality of devices in an IoT environment is provided. The communication hierarchy includes one or more parent-child relationships among the plurality of devices defining communication paths to be used for communication between devices on different levels of the communication hierarchy. The first device is configured to perform any of the method steps presented herein with respect to the first aspect.

The first device may comprise at least one processor and at least one memory, wherein the at least one memory contains instructions executable by the at least one processor such that the first device is operable to perform any of the method steps presented herein with respect to the first aspect.

According to a sixth aspect, a second device for establishing a communication hierarchy among a plurality of devices in an IoT environment is provided. The communication hierarchy includes one or more parent-child relationships among the plurality of devices defining communication paths to be used for communication between devices on different levels of the communication hierarchy. The second device is configured to perform any of the method steps presented herein with respect to the second aspect.

The second device may comprise at least one processor and at least one memory, wherein the at least one memory contains instructions executable by the at least one processor such that the second device is operable to perform any of the method steps presented herein with respect to the second aspect.

According to a seventh aspect, a computing unit for executing a configurator component for establishing a communication hierarchy among a plurality of devices in an IoT environment is provided. The communication hierarchy includes one or more parent-child relationships among the plurality of devices defining communication paths to be used for communication between devices on different levels of the communication hierarchy. The computing unit is configured to perform any of the method steps presented herein with respect to the third aspect.

The computing unit may comprise at least one processor and at least one memory, wherein the at least one memory contains instructions executable by the at least one processor such that the configurator component is operable to perform any of the method steps presented herein with respect to the third aspect.

According to an eighth aspect, there is provided a system comprising a first device according to the fifth aspect, a second device according to the sixth aspect and a computing unit according to the seventh aspect.

### BRIEF DESCRIPTION OF THE DRAWINGS

Embodiments of the technique presented herein are described herein below with reference to the accompanying drawings, in which:

FIG. 1 schematically illustrates an exemplary IoT environment in which a communication hierarchy is established among a plurality of IoT devices;

FIGS. 2a to 2c illustrate exemplary compositions of a first device, a second device and a computing unit for executing a configurator component in the IoT environment according to the present disclosure;

FIGS. 3a and 3b illustrate a conceptual composition of the first device and a corresponding method embodiment which may be performed by the first device;

FIGS. 4a and 4b illustrate a conceptual composition of the second device and a corresponding method embodiment which may be performed by the second device;

FIGS. 5a and 5b illustrate a modular composition of the computing unit for executing the configurator component and a corresponding method embodiment which may be performed by the configurator component;

FIG. 6 illustrates an exemplary sequence of operations performed among the first device, the second device and the configurator component in the IoT environment to establish a parent-child relationship in the communication hierarchy; and

FIG. 7 illustrates an IoT environment with an established communication hierarchy among a plurality of devices in an exemplarily logistics use case.

### DETAILED DESCRIPTION

In the following description, for purposes of explanation and not limitation, specific details are set forth in order to provide a thorough understanding of the present disclosure. It will be apparent to one skilled in the art that the present disclosure may be practiced in other embodiments that depart from these specific details. For example, while a specific implementation will be described with reference to an IoT system deployed in a logistics use case, it will be understood that the present disclosure shall not be limited to such use case and that the technique presented herein may be practiced in any other IoT environment.

Those skilled in the art will further appreciate that the steps, services and functions explained herein below may be implemented using individual hardware circuitry, using software functioning in conjunction with a programmed micro-processor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories are encoded with one or more programs that perform the steps, services and functions disclosed herein when executed by the one or more processors.

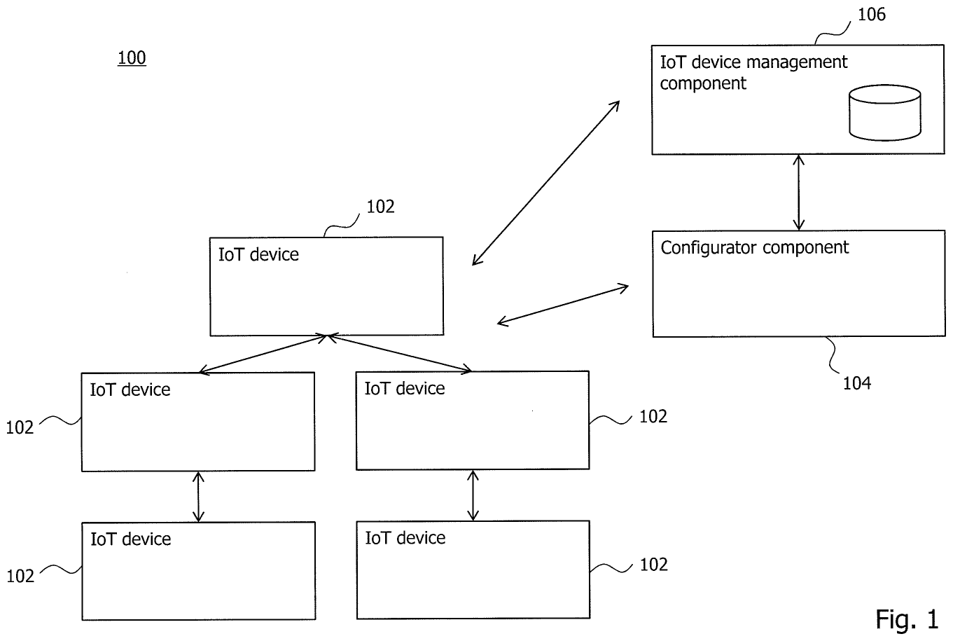

FIG. 1 schematically illustrates an exemplary an IoT environment 100 in which a plurality of devices 102 (denoted as “IoT devices” in the figure) are deployed. The plurality of devices 102 may correspond to interrelated physical objects equipped with computing, networking and, optionally, sensing capabilities, as described above for IoT systems of the prior art. Among the plurality of devices 102, a communication hierarchy is established that includes parent-child relationships defining communication paths to be used for communication between devices on different levels of the communication hierarchy. In the example of FIG. 1, the communication hierarchy comprises three levels, wherein a parent device 102 on the upper level of the hierarchy has two parent-child relationships with respective child devices 102 on the middle level of the hierarchy, and wherein each device 102 on the middle level represents itself a parent device 102 which has a parent-child relationship with a respective child device 102 on the lower level of the hierarchy.

As indicated in FIG. 1, the communication hierarchy may correspond to a network topology for both upstream and downstream message communication between the plurality of devices 102. When two devices 102 on different levels of the communication hierarchy communicate with each other, they may communicate along the communication paths defined by the parent-child relationships among the devices 102. More specifically, the devices 102 may communicate with each other along the communication paths defined by the parent-child relationships only. A communication path may either comprise a single parent-child relationship (in this case, the two devices 102 that communicate with each other are just one level away from each other) or a plurality of consecutive parent-child relationships that form a chain of parent-child relationships on which a message to be communicated from one device 102 to another device 102 may be forwarded (in this case, the two devices 102 that communicate with each other are more than one level away from each other). Thus, in a chain of parent-child relationships, a child device 102 may forward a message to its assigned parent device 102, and the parent device 102 may forward the message to its assigned parent device 102, and so on, e.g., until the message arrives at the desired destination. As shown in FIG. 1, a child device 102 may be a child for one device 102 and may be a parent for another device 102 (this applies to the devices 102 on the middle level of the hierarchy, for example). Also, while a child device 102 may only have one parent, a parent device 102 may have multiple child devices 102 (this applies to the devices 102 on the upper level of the hierarchy, for example). In other variants (not shown in FIG. 1), a child device may also have multiple parents. In the communication hierarchy, circular relationships may not be permitted, e.g., a device 102 may not be parent and child for another device 102 at the same time.

In order to establish the communication hierarchy among the plurality of devices 102, a parenting procedure (also denoted as “pairing procedure”) may be performed under control of a configurator component 104. The configurator component 104 may have (or have access to) parenting information defining the parent-child relationships of the communication hierarchy and may trigger—as part of the parenting procedure—establishing the parent-child relationships between respective pairs of the plurality of devices 102. The configurator component may in other words assign parent and child roles to the respective devices 102 in the IoT environment 100. The configurator component 104 may itself have knowledge of the parent-child relationships that are to be implemented during the parenting procedure (e.g., the configurator component 104 may store the corresponding configuration itself), or the configurator component 104 may obtain such knowledge from another entity, such as a device management component 106 provided in the IoT environment 100. The device management component 106 may be configured to keep track of the plurality of devices 102 in the IoT environment 100 (in particular of the locations of the devices 102 when at least part of the devices 102 are mobile or transportable), to monitor and keep track of the established parent-child relationships in the communication hierarchy, and to support the configurator component 104 in the parenting procedures for establishing the communication hierarchy among the devices 102, for example. Alternatively or additionally, at least part of the parent-child relationships may be configured manually by a user of the configurator component, e.g., based on physical properties of the devices 102 to be paired.

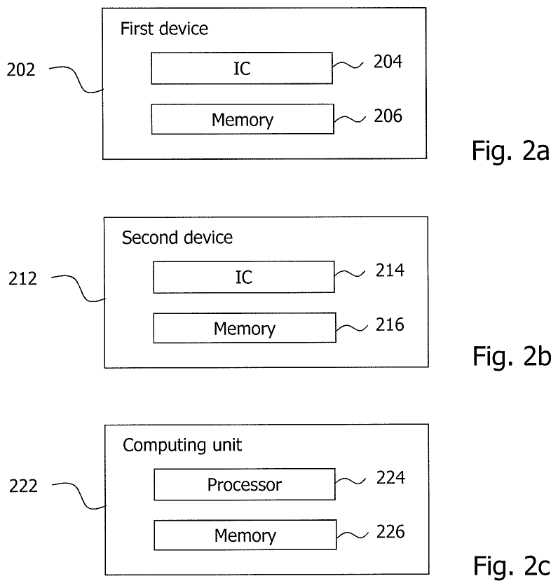

FIG. 2a illustrates an exemplary composition of a first device 202 among the devices 102. The first device 202 is configured to carry out the method steps described herein with reference to the “first device”. As a mere example, the first device 202 may comprise an integrated circuit (IC) 204 and a memory 206 which may be coupled to the IC 204 to enable the first device 202 to carry out corresponding method steps. It will be understood that the IC 204 may take a simple form, such as in the case of an active RFID tag attached to the underlying physical object, but may also take a more complex form, such as in the case of a processor which is coupled to the memory 206, in which case the memory 206 may contain instructions executable by the processor such that the first device 202 is operable to carry out the method steps described herein.

FIG. 2b illustrates an exemplary composition of a second device 212 among the devices 102. The second device 212 is configured to carry out the method steps described herein with reference to the “second device”. Similar to the first device 202, the second device 212 may comprise an IC 214 and a memory 216 which may be coupled to the IC 214 to enable the second device 212 to carry out corresponding method steps. It will be understood that the IC 214 may take a simple form, such as in the case of an active RFID tag attached to the underlying physical object, but may also take a more complex form, such as in the case of a processor which is coupled to the memory 216, in which case the memory 216 may contain instructions executable by the processor such that the second device 212 is operable to carry out the method steps described herein.

The first device 202 may correspond to a parent device and the second device 212 may correspond to a child device of a parent-child relationship in the communication hierarchy depicted in FIG. 1. It will be understood, however, that the principles of the technique presented herein may likewise be practiced when the first device 202 corresponds to a child device and the second device 212 corresponds to a parent device of a parent-child relationship in the communication hierarchy shown in FIG. 1.

FIG. 2c illustrates an exemplary composition of a computing unit 222 for executing the configurator component 104. The computing unit 222 may comprise at least one processor 224 and at least one memory 226, wherein the at least one memory 226 contains instructions executable by the at least one processor 224 such that the computing unit 222 is operable to carry out the method steps described herein with reference to the “configurator component”. The computing unit 222 may thus itself be denoted as a configurator component. It will be understood that the computing unit 222 may be a physical computing unit (in which case the computing unit 222 may be denoted as a configurator device), but may be virtualized computing unit as well, such as a virtual machine, for example. It will further be understood that the computing unit 222 does not necessarily have to be a standalone computing unit, but may be implemented as components—realized in software and/or hardware—on a single or on multiple computing units (being either physical or virtual) as well.

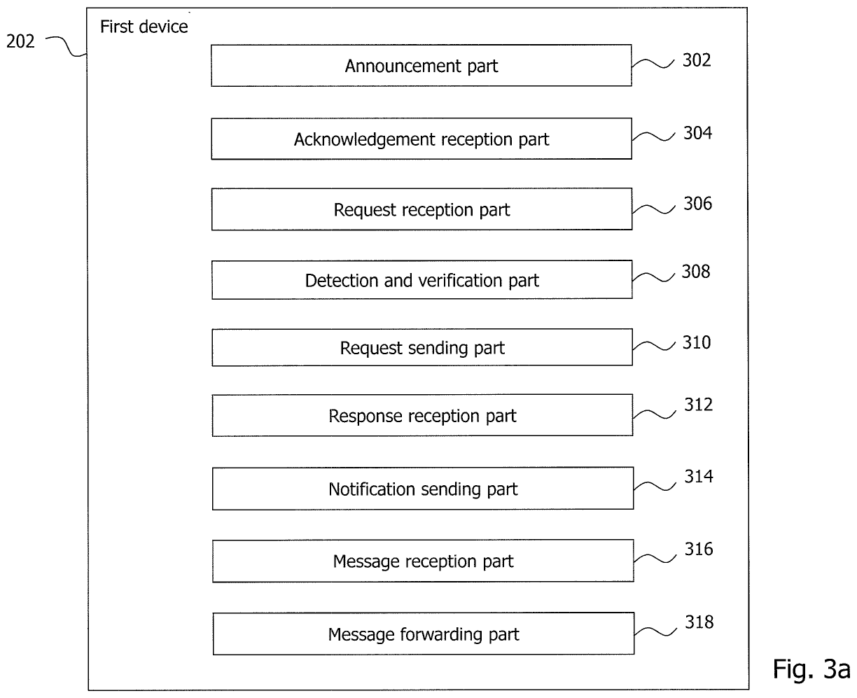

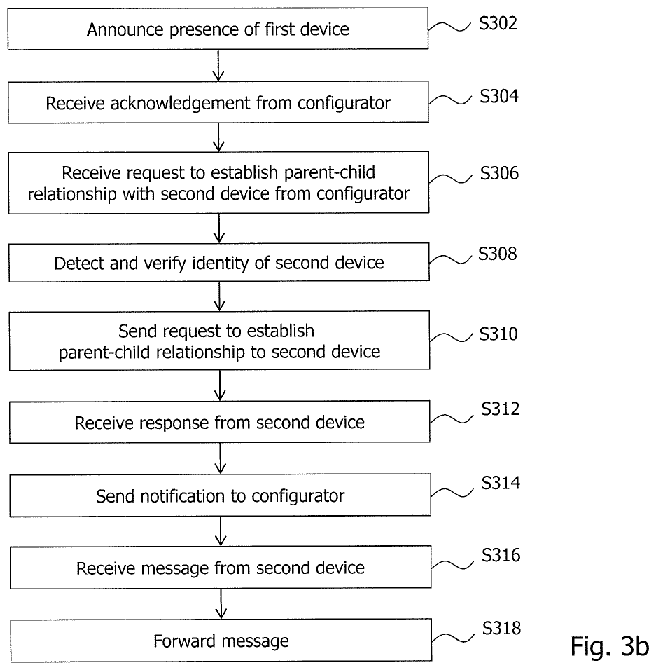

FIG. 3a schematically illustrates an exemplary conceptual composition of the first device 202 and FIG. 3b illustrates a corresponding method embodiment which may be performed by the first device 202 according to the present disclosure. The method is dedicated to establishing a parent-child relationship between the first device 202 and the second device 212. The basic operation of the first device 202 will be described in the following with reference to both FIGS. 3a and 3b.

To announce presence of the first device 202 and thereby enable other entities in the IoT environment 100 to detect the first device 202, such as the configurator component 104, an announcement part 302 of the first device 202 may send, in step S302, a broadcast announcing presence of the first device 202. The broadcast may be sent periodically and, once detected by another entity, an acknowledgment reception part 304 of the first device 202 may receive, in step S304, an acknowledgment in response to the broadcast, e.g., from the configurator component 104 to inform the first device 202 that a configurator component is available and within reach of the first device 202. The first device 202 may also enter a sleep mode between periodic broadcasts to save energy, e.g., until an acknowledgment is received.

In step S306, a request reception part 306 of the first device 202 may receive, from the configurator component 104, a configuration request to establish the parent-child relationship with the second device 212. The configuration request may include configuration information required by the first device 202 to establish the parent-child relationship with the second device 212. For example, the configuration information may include at least one of identification information of the second device 212 (e.g., a device address and/or device type) and security information required for establishing a connection with the second device 212, such as authentication information expected by the second device 212 (e.g., credentials), or encryption information (e.g., encryption keys) required for secure communication between the first device 202 and the second device 212.

Before establishing the parent-child relationship with the second device 212, a detection and verification part 308 of the first device 202 may search for the second device 212 (e.g., scan for the second device 212 within its radio range) if the second device 212 is not yet known or visible to the first device 202. The detection and verification part 308 may thus, in step S308, detect a broadcast announcing presence of the second device 212 and may then match the configuration information (e.g., device address and/or device type) with information included in the broadcast to verify the identity of the second device 212. Upon successful verification of the second device 212, a request sending part 310 of the first device 202 may send, in step S310, to the second device 212, an establishment request to establish the parent-child relationship with the second device 212. Establishing the parent-child relationship with the second device 212 may include establishing a connection between the first device 202 and the second device 212 usable for communication along a communication path in the communication hierarchy of FIG. 1, as described above. The connection may be established using a stateful or a stateless communication protocol and establishing the connection may comprise performing an initial handshake required to set up the parent-child relationship between the first device 202 and the second device 212. In the handshake, the configuration information (or at least parts thereof) may be exchanged with the second device 212.

Upon acceptance of the establishment request by the second device 212, a response reception part 312 of the first device 202 may receive, in step S312, from the second device 212, an establishment response confirming acceptance of the parent-child relationship with the first device 202. Otherwise, when the second device 212 has not accepted the establishment request, the response reception part 312 may receive a response indicating denial of the parent-child relationship from the second device 212. In case of acceptance by the second device 212, a notification sending part 314 of the first device 202 may send, in step S314, to the configurator component 104, a notification on completion of establishment of the parent-child relationship between the first device 202 and the second device 212. A notification may similarly be sent in case of failure to establish the parent-child relationship to inform the configurator component 104 accordingly.

As mentioned above, when a communication path between two devices 102 on different levels of the communication hierarchy forms a chain of consecutive parent-child relationships, a child device 102 may forward a message to its assigned parent device 102, and the parent device 102 may forward the message to its assigned parent device 102, and so on. When the first device 202 is thus additionally in a parent-child relationship with a third device 102, wherein the parent-child relationship with the third device 102 is consecutive to the parent-child relationship with the second device 212 (with reference to the communication hierarchy depicted in FIG. 1, this is the case when the first device 202 is on the middle level of the hierarchy, the second device 212 is on the lower level of the hierarchy and the third device 102 is on the upper level of the hierarchy), a message reception part 316 of the first device 202 may receive, in step S316, a message from the second device 212 via the connection established between the first device 202 and the second device 212. A message forwarding part 318 of the first device 202 may then forward, in step S318, the message to the third device 102 via a connection established between the first device 202 and the third device 102. The parent-child relationship and the corresponding connection between the first device 202 and the third device 102 may be established in an equivalent manner as described above for the parent-child relationship between the first device 202 and the second device 212.

Whereas the first, second and third devices 202, 212 and 102 as well as, optionally, the configurator component 104 may in some implementations establish connectivity among each other using wire-bound networks provided in the IoT environment 100, or using regular mobile communication networks, such as 4G or 5G networks, for example, in other implementations, the first device 202 may communicate with at least one of the second device 212, the third device 102 and the configurator component 104 using low energy radio technology. This may particularly be the case when the first, second and third devices 202, 212 and 102 and, optionally, the configurator component 104 are in close proximity to each other, i.e., when these entities are in reachable range to each other and may directly communicate with each other using low energy radio technology. Detecting the second device 212 based on the broadcast according to step S308 and establishing a connection with the second device 212 according to step S310 may then be carried out using low energy radio technology.

Low energy radio technology as known in the art may correspond to radio technology which provides considerably reduced power consumption as compared to classic radio technology. Low energy radio technology may comprise LP-PAN radio technology, such as BLE, for example, which may support wireless radio ranges in the order of meters up to tens of meters and which may enable devices to work for long periods of time using a coin battery cell, for example. For a wider range, BLE LR technology may be employed in which networks having star or mesh topologies with intermediate relaying nodes may be provided. ZigBee is another exemplary LP-PAN radio technology which is particularly designed for low data rate, low power and low cost applications, whose transmission ranges are typically below 100 meters and which may similarly support star, mesh and cluster tree topologies. Low energy radio technology may also include RFID technology which, in particular in case of active RFID, may support transmission radio ranges up to a few meters, such as three meters, for example. For wider ranges, it is also conceivable to employ LP-WAN technology with transmission radio ranges of a few up to tens of kilometers and battery lives of several years, including NB-IoT and LTE-MTC operating in licensed band and LoRaWAN and Sigfox operating unlicensed band, for example.

In addition to connectivity along the communication paths defined by the parents child relationships in the communication hierarchy, as described above, the first device 202 may further be equipped with Internet access and may therefore act as a gateway device which is able to communicate—apart from the communication hierarchy (or as the uppermost level of the communication hierarchy if the Internet connection is considered as part of the communication hierarchy)—with a remote entity via the Internet. The first device 202 may thus have an Internet connection and, when the first device 202 receives a message from the second device 212 via the connection established between the first device 202 and the second device 212 in step S316, the message forwarding part 318 of the first device 202 may alternatively forward the message, in step S318, to a remote entity via the Internet connection. To be able to access the remote entity, the first device 202 may receive, from the configurator component 104, connectivity information (e.g., a network address, port information, security information and/or subscription information, as needed) for accessing the remote entity via the Internet connection. Alternatively, the connectivity information may already be preconfigured in the first device 202. Similar to establishing a connection with the second device 212, the first device 202 may send an establishment request to establish connectivity (e.g., authenticate) with the remote entity and receive a corresponding establishment response therefrom. The first device 202 may also send a notification on the completion or failure of the connection establishment with the remote entity to the configurator component 104. The remote entity may be the device management component 106, for example. As another example, the remote entity may be the configurator component 104 in case the configurator component is a remote configurator component that may not be able to communicate with the devices 102 using low energy radio technology but only via the Internet through the gateway device, for example.

Further than the communication paths used for communication between the devices 102 in the IoT environment 100, the communication hierarchy may also define a supervision hierarchy in which, for each of the parent-child relationships in the communication hierarchy, a parent device 102 of the respective parent-child relationship monitors a status of a child device 102 of the respective parent-child relationship. The parent-child relationships may in other words also be said to define supervision responsibilities among the devices 102 in the IoT environment 100. When the first device 202 corresponds to a parent device and the second device 212 corresponds to a child device of the parent-child relationship, the first device 202 may thus monitor a status of the second device 212 and report the status of the second device accordingly. The first device 202 may send a report message along the upstream network topology of the communication hierarchy, e.g., as an event, and/or, when the first device 202 is a gateway device, the first device 202 may send the report message via the Internet connection to the device management component 106, for example. The report message may be a message which is forwarded in step S318. Reports may be sent according to reporting configuration parameters, such as desired report types and/or report intervals, for example, which may be preconfigured in the first device 202 or which may be included in the configuration information received from the configurator component 104. The reporting configuration parameters may also be included in the notification on completion or failure of the connection establishment between the first device 202 and the second device 212 sent to the configurator component 104 in order to confirm the reporting configuration parameters towards the configurator component 104.

The reported status of the second device 212 may generally relate to any status of the second device, including a connection status or a regular sensor status in case the second device 212 comprises a sensor, for example. A connection status of the second device 202 may be determined to be offline when it is detected that the parent-child relationship between the first device 202 and the second device 212 is broken. A parent-child relationship may be determined to be broken when connectivity between the first device 202 and the second device 212 is lost. Lost connectivity may be detected based on a message report interval (e.g., a heartbeat or a regular sensor report interval) that is sent periodically to keep alive the connection of the parent-child relationship. If a lost device reappears after a certain period of time, such device may no longer be considered as a valid device in the communication hierarchy and a reparenting procedure may be required to be executed. In case a parent device is considered as an invalid device, all of its child devices may be considered to be invalid as well and may need to be reparented.

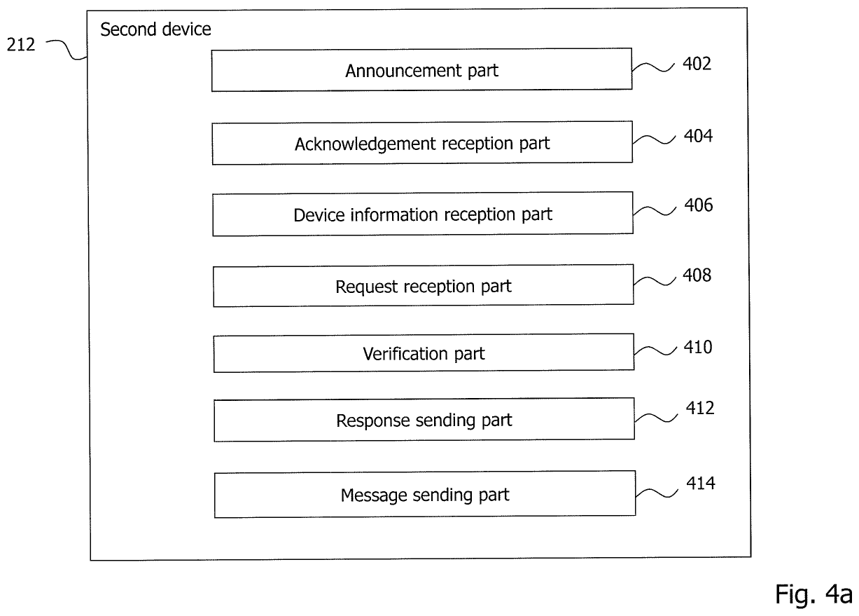

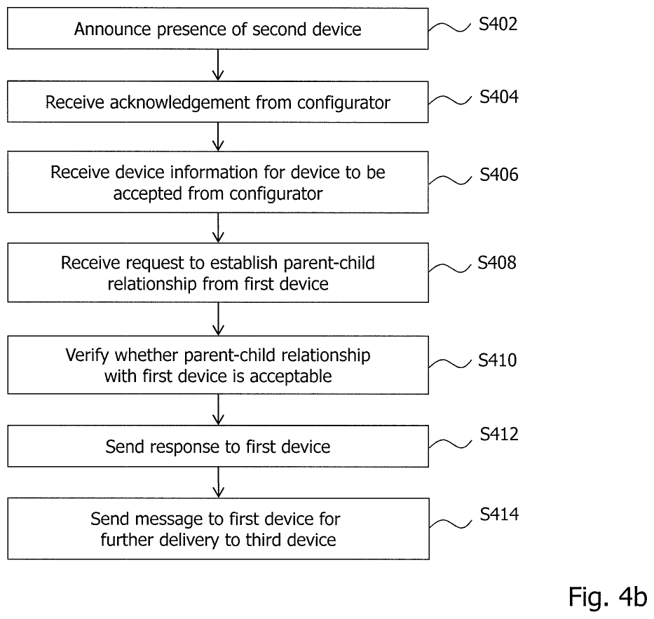

FIG. 4a schematically illustrates an exemplary conceptual composition of the second device 212 and FIG. 4b illustrates a corresponding method embodiment which may be performed by the second device 212 according to the present disclosure. As the method of FIG. 3a, the method is dedicated to establishing a parent-child relationship between the first device 202 and the second device 212. The basic operation of the second device 212 will be described in the following with reference to both FIGS. 4a and 4b.

In order to enable the first device 202 and the configurator component 104 to detect the second device 212, an announcement part 402 of the second device 212 may send, in step S402, a broadcast announcing presence of the second device 212 to other entities in the IoT environment 100. The broadcast may be sent periodically and, once detected by another entity, an acknowledgment reception part 404 of the second device 212 may receive, in step S404, an acknowledgment in response to the broadcast, e.g., from the configurator component 104 to inform the second device 212 that a configurator component is available and within reach of the second device 212 (e.g., nearby if communication with the configurator component 104 is carried out using low energy radio technology). The second device 212 may also enter a sleep mode between periodic broadcasts to save energy, e.g., until an acknowledgment is received.

In order to know about a device with which a parent-child relationship may be established, a device information reception part 406 of the second device 212 may receive, in step S406, device information from the configurator component 104, wherein the device information indicates from which device an establishment request for establishing a parent-child relationship is to be accepted. Alternatively, the device information indicating from which device an establishment request for establishing a parent-child relationship is to be accepted may be preconfigured in the second device 212. The device information may comprise authentication information (e.g., credentials) expected to be received from the first device 202 for authentication purposes and/or encryption information (e.g., encryption key) required to decrypt at least part of the establishment request, for example.

In step S408, a request reception part 408 of the second device 212 may receive, from the first device 202, the establishment request to establish the parent-child relationship with the first device 202. The establishment request may include at least one of identification information of the first device 202 (e.g., a device address and/or device type) and security information required for establishing the connection between the first device 202 and the second device 212, such as authentication information expected by the second device 212 (e.g., credentials), or encryption information (e.g., encryption keys) required for secure communication between the first device is 202 and the second device 212.

Upon receiving the establishment request from the first device 202, a verification part 410 of the second device 212 may match, in step S410, the device information with information included in the establishment request (e.g., the identification information and the authentication information of the first device 202) to verify whether establishing the parent-child relationship with the first device 202 is acceptable. The verification may also include decrypting at least part of the establishment request using the encryption information included in the device information received from the configurator component 104. Verification may fail when the decryption of at least part of the establishment request fails. Upon acceptance of the establishment request, a response sending part 412 of the second device 212 may send, in step S412, to the first device 202, an establishment response confirming acceptance of the parent-child relationship with the first device 202. As an alternative to sending the notification on completion or failure of the connection establishment between the first device 202 and the second device 212 from the first device 202 to the configurator component 104, as described above in relation to step S314, such notification may also be sent by the second device 212, for example.

As described above, when a communication path between two devices 102 on different levels of the communication hierarchy comprises a plurality of consecutive parent-child relationships forming a chain of parent-child relationships, a child device 102 may for a message to its assigned parent device 102, and the parent device 102 may forward the message to its assigned parent device 102, and so on. When the first device 202 is thus additionally in a parent-child relationship with a third device 102, wherein the parent-child relationship with the third device 102 is consecutive to the parent-child relationship with the second device 212, a message sending part 414 of the second device 212 may send, in step S414, a message to the first device 202 via the connection established between the first device 202 and the second device 212, wherein the message is dedicated for further delivery from the first device 202 to the third device 102 via a connection established between the first device 202 and the third device 102.

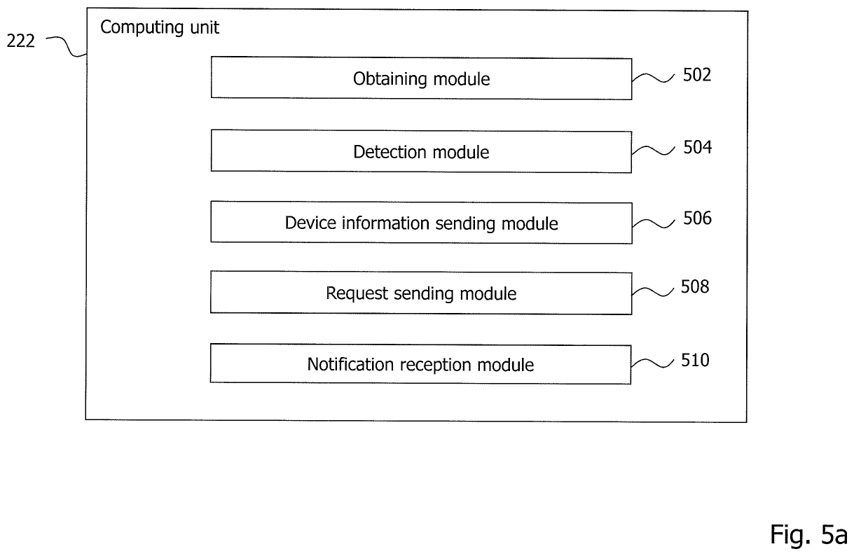

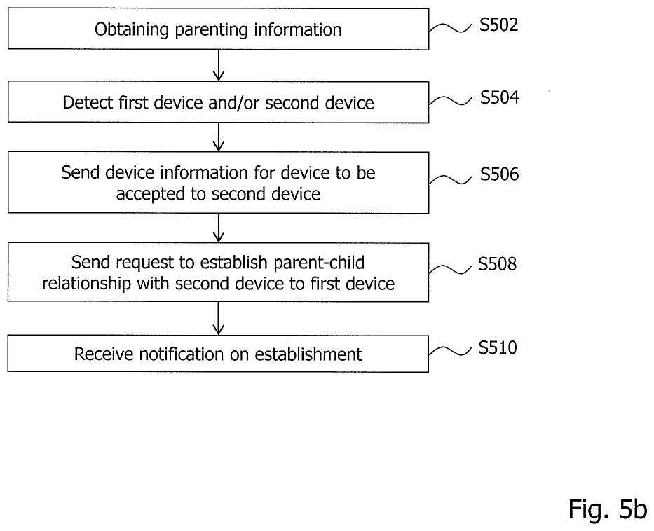

FIG. 5a schematically illustrates an exemplary modular composition of the computing unit 222 for executing the configurator component 104 and FIG. 5b illustrates a corresponding method embodiment which may be performed by the computing unit 222 according to the present disclosure. As the methods of FIGS. 3a and 4a, the method is dedicated to establishing a parent-child relationship between the first device 202 and the second device 212. The basic operation of the computing unit 222 will be described in the following with reference to both FIGS. 5a and 5b.

In case the configurator component 104 does not have knowledge of the parent-child relationships that are to be implemented during the parenting procedure, an obtaining module 502 of the computing unit 222 may obtain, in step S502, from the device management component 106, parenting information defining the parent-child relationships of the communication hierarchy. In step S504, a detection module 504 of the computing unit 222 may search for the first device 202 (e.g., scan for the first device 202 within its radio range), and optionally the second device 212, if the first device 202 and the second device 212 are not yet visible to the configurator component 104. The detection module 504 may thus receive a broadcast from at least one of the first device 202 and the second device 212 announcing its respective presence in the IoT environment 100 and thereby detect the first device 202 and/or the second device 212.

Further, in order to inform the second device 212 about a device with which the parent-child relationship may be established, a device information sending module 506 may send, in step S506, device information to the second device 212, wherein the device information indicates to the second device 212 from which device an establishment request for establishing a parent-child relationship is to be accepted. In step S508, a request sending module 508 of the computing unit 222 may send, in step S508, to the first device 202, the configuration request to establish the parent-child relationship with the second device 212. The configuration request may be generated based on the parenting information obtained by the configurator component 104 in step S502. When the parent-child relationship has been successfully established between the first device 202 and the second device 212, a notification reception module 510 of the computing unit 222 may receive, in step S510, from at least one of the first device 202 and the second device 212, a notification on completion of establishment of the parent-child relationship between the first device 202 and the second device 212. A notification may similarly be received in case of a failure in establishing a parent-child relationship.

The computing device 222 may be configured to communicate with at least one of the first device 202 and the second device 212 using low energy radio technology. This may particularly be the case when the computing device 222 is in close proximity to the first device 202 and the second device 212, i.e., when they are in reachable range and may directly communicate with each other using low energy radio technology. The computing unit 222 may in this case be a mobile computing unit, such as a smartphone or a laptop, for example, that may be employed locally (i.e., at a location where the first device 202 and the second device 212 are located as well) to trigger establishing the parent-child relationship between the first device 202 and the second device 212. Such computing unit may be denoted as a local configurator component. As an alternative, the computing unit 222 may execute a remote configurator component that may not be able to communicate with the first device 202 and the second device 212 using low energy radio technology but only via the Internet if the first device 202 and/or the second device 212 is configured as a gateway device, for example. If the computing unit 222 executes a remote configurator component, the computing unit 222 may reside in a cloud, for example.

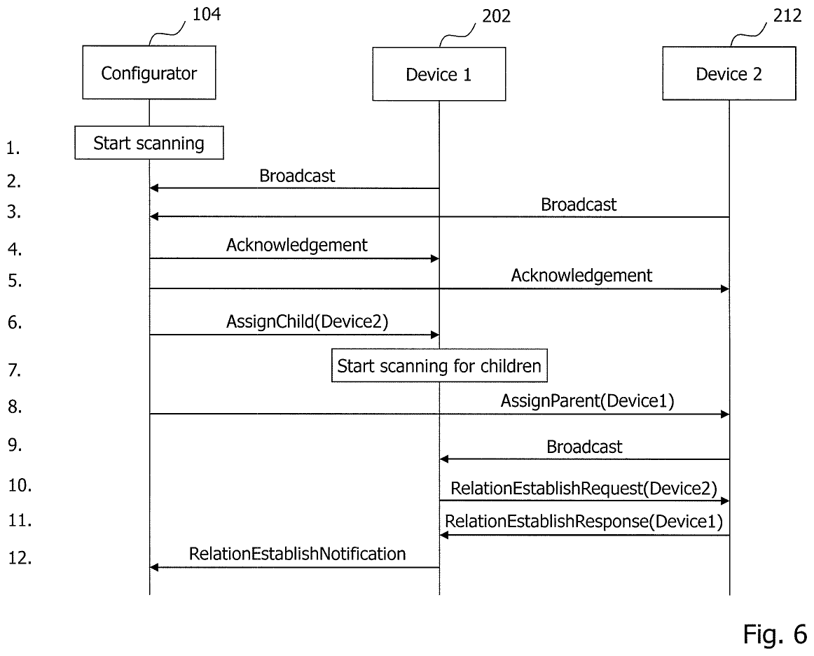

FIG. 6 illustrates an exemplary sequence of operations performed among the configurator component 104, the first device 202 and the second device 212 in a parenting procedure for establishing a parent-child relationship in the communication hierarchy of the IoT environment 100 by means of a sequence diagram. In the example of FIG. 6, the first device 202 is assigned the parent role and the second device 212 is assigned the child role of the parent-child relationship. In step 1 of the sequence, the configurator component 104 starts scanning for the first device 202 and the second device 212 (e.g., within its radio range) in line with step S504 described above. In step 2, the first device 202 sends a broadcast announcing presence of the first device 202 in line with step S302 described above and, in step 3, the second device 212 sends a broadcast announcing presence of the second device 212 in line with step S402 described above. The configurator component 104 receives the broadcasts, detects the first device 202 and the second device 212 in line with step S504 described above and sends, in steps 4 and 5, corresponding acknowledgments to the first device 202 and the second device 212 in line with steps S304 and S404 described above. In step 6, the configurator component 104 assigns the second device 212 as a child device to the first device 202 by sending, to the first device 202, a configuration request to establish the parent-child relationship with the second device 212 in line with steps S508 and S306 described above. In step 7, the first device 202 starts scanning for the second device 212 (e.g., within its radio range) in line with step S308 described above. In step 8, the configurator component 104 assigns the first device 212 as a parent device to the second device 212 by sending device information of the first device 202 to the second device 212 to indicate to the second device 212 that an establishment request for establishing the parent-child relationship is to be accepted from the first device 202 in line with steps S506 and S406 described above. It will be understood that step 8 is only optional and may be omitted in case the device information of the first device 202 is already preconfigured in the second device 212. In step 9, the second device 212 sends a broadcast to enable the first device 202 to detect and verify the identity of the second device 212 in line with step S308 described above. Further, in step 10, the first device 202 sends, to the second device 212, an establishment request to establish the parent-child relationship with the second device 212 in line with steps S310 and S408 described above. In step 11, the second device 212 sends a corresponding establishment response to the first device 202 confirming acceptance of the parent-child relationship in line with steps S312 and S412 described above. Finally, in step 12, the first device 202 sends a notification on completion of establishment of the parent-child relationship between the first device 202 and the second device 212 to the configurator component 104 in line with steps S314 and S510 described above.

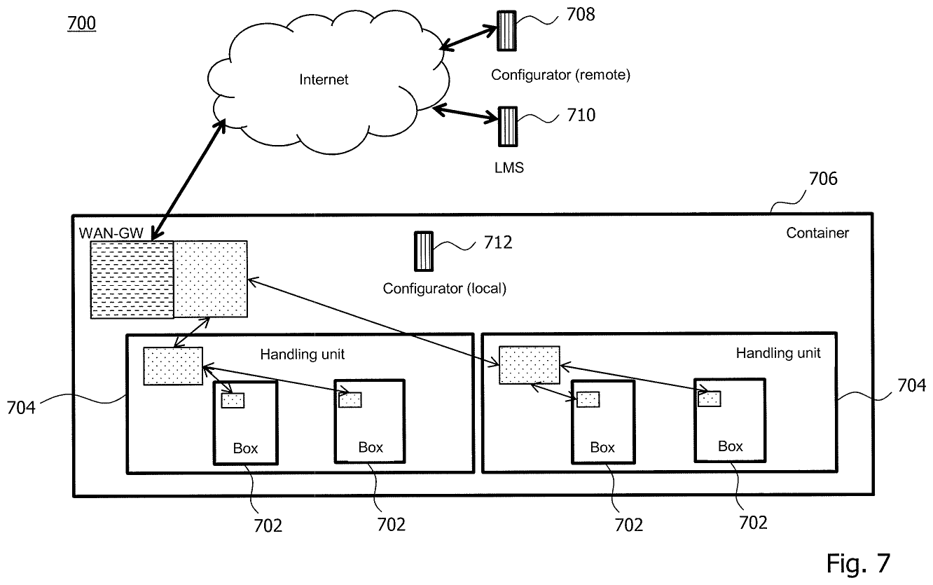

FIG. 7 illustrates an IoT environment 700 with an established communication hierarchy among a plurality of devices in an exemplary logistics use case. It will be understood that the logistics use case is merely exemplarily and dedicated to elucidate how the technique presented herein may be practiced in a real-world example of an IoT system. The skilled person will appreciate that technique presented herein may be practiced in any other conceivable IoT environment.

In the example of FIG. 7, product boxes 702 correspond to IoT devices on the lower level of the established communication hierarchy. The product boxes 702 are collected into handling unit boxes 704 which correspond to IoT devices on the middle level of the communication hierarchy. The handling unit boxes 704, in turn, are placed into a large container 706 for shipment to another location. The container 706 corresponds to an IoT device on the upper level of the communication hierarchy which comprises a WAN gateway and may therefore act as a gateway device in the sense of the present disclosure. Each of the product boxes 702, the handling unit boxes 704 and the container 706 are equipped with computing, networking and, optionally, sensing capabilities. The computing, networking and sensing capabilities may be realized by attaching smart labels to these physical objects, such as active RFID tags or BLE chips with single coin battery cells that support communication using low energy radio technology, for example.

The parent-child relationships among the container 706, the handling unit boxes 704 and the product boxes 702 are indicated by respective arrows in FIG. 7. As can be seen, the product boxes 702 contained in the left handling unit box 704 correspond to child devices of the left handling unit box 704 and the product boxes 702 contained in the right handling unit box 704 correspond to child devices of the right handling unit box 704. The handling unit boxes 704, in turn, correspond to child devices of the container 706. The container 706 has Internet access through the WAN gateway and may therefore communicate via the Internet with a remote configurator component 708 and a device management component 710 which, in the illustrated logistics use case, corresponds to a logistics management system (LMS). If a message needs to be sent from a product box 702 to the LMS 710, such as in case of a status change of the product box 702, the message is forwarded along the configured network topology, i.e., from the product box 702 to its parent handling unit box 704, from the handling unit box 704 to the container 706, and from the container 706 to the LMS 710.

Establishment of the parent-child relationships between the product boxes 702, the handling boxes 704 and the container 706 may be effected under control of a local configurator component 712 which carries out required parenting procedures among the devices. The local configurator component 702 may correspond to a smartphone or laptop operated by logistics service personnel that establishes the parent-child relationships when the product boxes 702 are prepared for shipment in a warehouse, for example. During shipment, changes in the parent-child relationships (e.g., required reparenting procedures when connection to a product box 702 has been lost) may be carried out by the remote configurator component 708.

As has become apparent from the above, the present disclosure provides a technique for establishing a communication hierarchy among a plurality of devices in an IoT environment. The technique may enable automatic creation of a network topology usable for communication and supervision under control of, and based on a configuration provided by, a configurator component. In this way, a robust and secure network environment may be created in a controlled manner, where associations between different levels of the devices in the environment may be validated by the configurator component. The created network topology may enable keeping track, monitoring and sensing the status of the network as well as the IoT devices included therein throughout their lifecycle. By the employed communication technology, the network topology may be created and monitored without the need for human interaction and potential human errors may therefore be reduced.

Like in the exemplarily logistics use case described above, the technique presented herein may be used to optimize logistic processes in a considerable manner. Each IoT device may correspond to a specific container, wherein larger containers may reside on higher layers of the topology hierarchy and smaller containers which are put inside a larger container may correspond to child devices. The controlled network topology may facilitate communication separation between different categories of goods for privacy and security purposes, for example. When the goods are offloaded from a truck or a ship, for example, a subset of the network topology may remain unchanged until the parent topology is changed, e.g., when the larger container is opened and the smaller boxes are moved around in a warehouse. Further, due to the hierarchical network topology, it may be easy for a parent device to keep track of all of its child devices.

By the technique presented herein, problems of existing logistics systems in which goods are typically registered upon arrival to a hub or a final destination using passive technology, such as short-range machine readable barcodes, human readable labels or passive RFID technology, may be overcome. Since information about the goods may only be available at certain points in the distribution chain of such systems, there may be a long time span where no information about the transported goods is available. Further, reconfiguration of the network may require human interaction which may be inefficient, time-consuming and error-prone. For example, package contents may typically be handled by time-consuming manual pack lists, and items inside the packages may be ticked off from the list upon arrival or during repackaging. Using the technique presented herein, on the other hand, end to end tracking, monitoring and control of IoT devices may be realized throughout the entire lifecycle of the IoT devices, including resource utilization from assembly of a product, delivery of the product as well as usage of the product by a customer, even at the end of the lifecycle when the product may be decomposed and its material may be recycled. Various functional requirements of logistics systems may thus be met, including real-time location tracking of goods, keeping track of mode of operations (e.g., the box being transported on a truck, ship or airplane) or intermediate storage of the goods (e.g., in a warehouse), alerting in case of damages or unexpected removal (e.g., theft) of goods from a box (which may be realized by sensing capabilities of the IoT device), identifying product content (e.g., “dangerous” goods) including treatment requirements ensuring that the goods are treated in the right way (e.g., temperature, humidity, etc.), transferring ownership at the destination, indicating recycling requirements for materials composing the goods, or the like.

It is believed that the advantages of the technique presented herein will be fully understood from the foregoing description, and it will be apparent that various changes may be made in the form, constructions and arrangement of the exemplary aspects thereof without departing from the scope of the invention or without sacrificing all of its advantageous effects. Because the technique presented herein can be varied in many ways, it will be recognized that the invention should be limited only by the scope of the claims that follow.

1-43. (canceled)

44. A first device for establishing a communication hierarchy among a plurality of devices in an Internet of Things environment, the communication hierarchy including one or more parent-child relationships among the plurality of devices defining communication paths to be used for communication between devices on different levels of the communication hierarchy, the first device comprising:
at least one processor; and
at least one memory, the at least one memory containing instructions executable by the at least one processor such that the first device is configured to:
receive, from a configurator component, a configuration request to establish a parent-child relationship with a second device of the plurality of devices; and
send, to the second device, an establishment request to establish the parent-child relationship with the second device, wherein establishing the parent-child relationship includes establishing a connection between the first device and the second device usable for communication along a communication path in the communication hierarchy, wherein
the first device is configured to communicate with at least one of the second device or the configurator component using low energy radio technology.

45. The first device of claim 44, wherein the first device corresponds to a parent device and the second device corresponds to a child device of the parent-child relationship.

46. The first device of claim 44, wherein
the configuration request includes configuration information required by the first device to establish the parent-child relationship with the second device, and
the configuration information includes at least one of identification information of the second device and security information required for establishing the connection with the second device.

47. The first device of claim 44, wherein
the configuration request includes configuration information required by the first device to establish the parent-child relationship with the second device, and
the first device is further configured to:
detect a broadcast announcing presence of the second device; and
match the configuration information with information included in the broadcast to verify an identity of the second device.

48. The first device of claim 44, wherein the first device is in a parent-child relationship with a third device of the plurality of devices, the parent-child relationship with the third device being consecutive to the parent-child relationship with the second device, and wherein the first device is further configured to:
receive a message from the second device via the connection established between the first device and the second device; and
forward the message to the third device via a connection established between the first device and the third device.

49. The first device of claim 44, wherein the first device has an Internet connection, and wherein the first device is further configured to:
receive a message from the second device via the connection established between the first device and the second device;
forward the message to a remote entity via the Internet connection; and
receive, from the configurator component, connectivity information for accessing the remote entity via the Internet connection.

50. The first device of claim 44, wherein, when the first device corresponds to a parent device and the second device corresponds to a child device of the parent-child relationship, the first device is further configured to:
monitor a status of the second device; and
report the status of the second device.

51. The first device of claim 50, wherein the status of the second device is determined to be offline when it is detected that the parent-child relationship between the first device and the second device is broken.

52. A second device for establishing a communication hierarchy among a plurality of devices in an Internet of Things environment, the communication hierarchy including one or more parent-child relationships among the plurality of devices defining communication paths to be used for communication between devices on different levels of the communication hierarchy, the second device comprising:
at least one processor; and
at least one memory, the at least one memory containing instructions executable by the at least one processor such that the second device is configured to:
receive, from a first device of the plurality of devices, an establishment request to establish a parent-child relationship with the first device, wherein establishing the parent-child relationship includes establishing a connection between the first device and the second device usable for communication along a communication path in the communication hierarchy, wherein
the second device is configured to communicate with at least one of the first device or a configurator component using low energy radio technology.

53. The second device of claim 52, wherein the establishment request includes at least one of identification information of the first device or security information required for establishing the connection between the first device and the second device.

54. The second device of claim 52, wherein the second device is further configured to:
receive, prior to receiving the establishment request, device information from the configurator component, the device information indicating from which device an establishment request for establishing a parent-child relationship is to be accepted; and
match the device information with information included in the establishment request to verify whether establishing the parent-child relationship with the first device is acceptable.

55. The second device of claim 52, wherein the second device is further configured to:
send, to the first device, an establishment response confirming acceptance of the parent-child relationship with the first device; and
send, prior to receiving the establishment request, a broadcast announcing presence of the second device.

56. The second device of claim 52, wherein the first device is in a parent-child relationship with a third device of the plurality of devices, the parent-child relationship with the third device being consecutive to the parent-child relationship with the second device, and wherein the second device is further configured to:
second a message to the first device via the connection established between the first device and the second device, the message being dedicated for further delivery from the first device to the third device via a connection established between the first device and the third device.

57. A configurator device for establishing a communication hierarchy among a plurality of devices in an Internet of Things environment, the communication hierarchy including one or more parent-child relationships among the plurality of devices defining communication paths to be used for communication between devices on different levels of the communication hierarchy, the configurator device comprising:
at least one processor; and
at least one memory, the at least one memory containing instructions executable by the at least one processor such that the configurator device is configured to:
send, to a first device of the plurality of devices, a configuration request to establish a parent-child relationship with a second device of the plurality of devices, wherein establishing the parent-child relationship includes establishing a connection between the first device and the second device usable for communication along a communication path in the communication hierarchy, wherein
the configurator device is configured to communicate with at least one of the first device or the second device using low energy radio technology.

58. The configurator device of claim 57, wherein
the first device corresponds to a parent device and the second device corresponds to a child device of the parent-child relationship, and
the configuration request includes configuration information required by the first device to establish the parent-child relationship with the second device.

59. The configurator device of claim 57, wherein the configuration information includes at least one of identification information of the second device or security information required for establishing the connection with the second device.

60. The configurator device of claim 57, wherein the configurator device is further configured to:
receive, prior to sending the configuration request, a broadcast from at least one of the first device and the second device announcing its respective presence.

61. The configurator device of claim 57, wherein the configurator device is further configured to:
send, prior to sending the configuration request, device information to the second device, the device information indicating to the second device from which device an establishment request for establishing a parent-child relationship is to be accepted.

62. The configurator device of claim 57, wherein the configurator device is further configured to:
receive, from at least one of the first device and the second device, a notification on completion of establishment of the parent-child relationship between the first device and the second device; and
obtain, from a device management component, parenting information defining the one or more parent-child relationships of the communication hierarchy, wherein
the configuration request is generated based on the parenting information.

63. A system comprising:
a first device;
a second device; and
a configurator device, wherein
the first device is configured to:
receive, from the configurator device, a configuration request to establish a parent-child relationship with the second device; and
send, to the second device, an establishment request to establish the parent-child relationship with the second device, wherein establishing the parent-child relationship includes establishing a connection between the first device and the second device usable for communication along a communication path in a communication hierarchy, wherein
the first device is configured to communicate with at least one of the second device or the configurator device using low energy radio technology.
